(19) United States
(12) Patent Application Publication
(10) Pub. No.: US 2024/0251716 A1
(43) Pub. Date: Aug. 1, 2024

(54) HANDHELD POWER TOOL WITH A SAFETY SWITCH

(71) Applicant: HUSQVARNA AB, Huskvarna (SE)

(72) Inventor: Per-Anders Bulow, Jonkoping (SE)

(21) Appl. No.: 18/565,580

(22) PCT Filed: May 19, 2022
(86) PCT No.: PCT/SE2022/050493

§ 371 Date: Nov. 30, 2023

(30) Foreign Application Priority Data
Jun. 1, 2021 (SE) 2150694-4

(51) Int. Cl. A01G 3/053; A01G 3/06; H01H 9/06

(52) U.S. Cl. CPC A01G 3/053; A01G 3/065; H01H 9/06

(57) ABSTRACT

A handheld power tool (1) is disclosed comprising a power tool body (3), a tool (2), a power source (4) configured to power the tool (2), a switch (10) configured to set the power tool (1) in an active-state or an inactive-state, and an elongated handle (20). The elongated handle (20) comprises a trigger element (30) being arranged movable relative the elongated handle (20) such that the trigger element (30) moves relative the handle (20) when a person grips the handle (20). The switch (10) is arranged at the power tool body (3). The power tool (1) comprises a mechanism (7) operably connected to the trigger element (30). The mechanism (7) is configured such that a first mechanism member (11) of the mechanism (7) is moved in a direction (d1) towards the switch (10) when the handle (20) is gripped.

### TECHNICAL FIELD

The present disclosure relates to a handheld power tool comprising a switch configured to set the power tool in an active-state or an inactive-state.

### BACKGROUND

A handheld power tool is a tool intended to be supported by one or two hands of a user during operation. Moreover, a handheld power tool comprises a tool which can be driven by a power source other than solely manual labour. The power source may for example comprise a combustion engine, an electric motor, a pneumatic motor, or the like. Today, there are many kinds of power tools available on the market. Examples are chain saws, circular saws, trimmers, hedge trimmers, string-trimmers, brush-cutters, multi-tools, and the like. Power tools are for example used in industry, in construction, in gardens, for housework tasks, and around houses for purposes of cutting, shaping, sanding, grinding, routing, polishing, and the like.

Power tools of various kind are associated with some mutual problems. One problem is safety. That is, a power tool can comprise a sharp tool and a powerful power source for powering the tool. Therefore, some power tools comprise a safety-switch which set the power tool in an active-state or an inactive-state based on whether a user is gripping a handle of the power tool. Such handles are often provided with safety mechanisms that ensures that the power tool is properly held during operation, for example that the power tool is held by both hands when used. Certain power tools, such as hedge-trimmers, may be turned in various directions during operation and therefore these power tools may be provided with handles and safety-switches that allow the user to hold the power tool in several positions including both horizontal and vertical positions.

The above mentioned types of safety-switches are capable of significantly increasing the safety during handling of a power tool. However, many of these features and functions add cost and complexity to the power tool, and in general, on today's consumer market, it is an advantage if products, such as power tools, have conditions and/or characteristics suitable for being manufactured and assembled in a cost-efficient manner.

Furthermore, a problem when designing power tools comprising a safety-switch is reliability and robustness of the safety-switch. This is because power tools usually operate in a demanding environment with a lot of dust, debris, water, vibrations, and the like, and that a malfunction of the safety-switch may cause dangerous situations.

Further general problems when designing power tools are compactness and user-friendliness. That is, it is an advantage if the power tool is designed such that a user can operate the power tool in an intuitive manner and a compact power tool may be simpler and less burdensome to use than a bulkier power tool.

### SUMMARY

It is an object of the present invention to overcome, or at least alleviate, at least some of the above-mentioned problems and drawbacks.

According to a first aspect of the invention, the object is achieved by a handheld power tool comprising a power tool body, a tool, a power source configured to power the tool, a switch configured to set the power tool in an active-state or an inactive-state, and an elongated handle to be held by a person using the power tool. The elongated handle comprises a trigger element extending along at least a portion of the elongated handle and being arranged movable relative the elongated handle such that the trigger element moves relative the handle when a person grips the handle. The switch is arranged at the power tool body. The power tool comprises a mechanism operably connected to the trigger element. The mechanism is configured such that a first mechanism member of the mechanism is moved in a direction towards the switch when the handle is gripped.

Since the mechanism is configured such that a first mechanism member of the mechanism is moved in a direction towards the switch when the handle is gripped, a power tool is provided having conditions for consistent and reliable activations and deactivations of the switch.

Moreover, since the switch is arranged at the power tool body, conditions are provided for shielding the switch from dust, debris, water, impact, vibrations, and the like. In this manner, a more robust and reliable power tool can be provided. As a further result of these features, a safer power tool can be provided.

In addition, since the switch is arranged at the power tool body, conditions are provided for a more compact power tool thus being simpler to use.

Accordingly, a power tool is provided overcoming, or at least alleviating, at least some of the above-mentioned problems and drawbacks. As a result, the above-mentioned object is achieved.

Optionally, the mechanism comprises a second mechanism member connected to the trigger element and to the first mechanism member, and wherein the first mechanism member is configured to move relative to the switch upon movement of the second mechanism member. Thereby, a power tool is provided having conditions for consistent and reliable activations and deactivations of the switch in a simple and efficient manner.

Optionally, the mechanism is configured such that the first mechanism member is moved relative to the switch upon a pivoting movement of the second mechanism member. Thereby, a power tool is provided having conditions for consistent and reliable activations and deactivations of the switch. Moreover, a power tool is provided having conditions for an activation of the switch upon movement of the trigger element in several directions relative to the elongated handle. In this manner, a power tool is provided having conditions for allowing a user to grip the elongated handle at various gripping directions during operation of the power tool in a simple and efficient manner.

Optionally, the second mechanism member is pivotally arranged around a first pivot axis. Thereby, a power tool is provided having conditions for consistent and reliable activations and deactivations of the switch in a simple and efficient manner.

Optionally, the second mechanism member is pivotally arranged around a second pivot axis being transversal to the first pivot axis. Thereby, a power tool is provided having conditions for consistent and reliable activations and deactivations of the switch. Moreover, a power tool is provided having conditions for an activation of the switch upon movement of the trigger element in several directions relative to the elongated handle. In this manner, a power tool is provided having conditions for allowing a user to grip the elongated handle at various gripping directions during operation of the power tool in a simple and efficient manner.

Optionally, the trigger element comprises an aperture, and wherein the second mechanism member comprises a knob protruding into the aperture. Thereby, a simple, efficient, and reliable transfer of movement can be provided between the trigger element and the second mechanism member. Moreover, a power tool is provided having conditions for an activation of the switch upon movement of the trigger element in several directions relative to the elongated handle. In this manner, a power tool is provided having conditions for allowing a user to grip the elongated handle at various positions during operation of the power tool in a simple and efficient manner.

Optionally, the second mechanism member comprises a recess, and wherein the second mechanism member is movable to a position in which a section of the first mechanism member protrudes into the recess. Thereby, a power tool is provided having conditions for consistent and reliable activations and deactivations of the switch in a simple, reliable, and cost-efficient manner.

Optionally, the first mechanism member is moved in the direction towards the switch when the section of the first mechanism member is moved out from the recess. Thereby, a power tool is provided having conditions for consistent and reliable activations and deactivations of the switch in a simple, reliable, and cost-efficient manner.

Optionally, the second mechanism member comprises an abutment surface adjacent to the recess, and wherein the second mechanism member is configured to move the first mechanism member in the direction towards the switch by an abutting contact between the abutment surface and the first mechanism member. Thereby, a power tool is provided having conditions for consistent and reliable activations and deactivations of the switch in a simple, reliable, and cost-efficient manner. Moreover, a power tool is provided having conditions for a distinct triggering point of the trigger element in which the position of the trigger element relative to the elongated handle causes an activation of the switch. In addition, due to these features, movement of the trigger element past the above mentioned triggering point can be allowed. In this manner, a more user-friendly power tool can be provided because the switch can be activated in a quick and efficient manner simply by gripping the elongated handle and unintentional deactivations of the switch, for example caused by a loose grip of the elongated handle, can be avoided.

Optionally, the abutment surface is curved and/or bowl-shaped. Thereby, a power tool is provided having conditions for a distinct triggering point of the trigger element in which the position of the trigger element relative to the elongated handle causes an activation of the switch. In addition, due to these features, movement of the trigger element past the triggering point can be allowed. In this manner, a more user-friendly power tool can be provided because the switch can be activated in a quick and efficient manner simply by gripping the elongated handle and unintentional deactivations of the switch, for example caused by a loose grip of the elongated handle, can be avoided.

Optionally, the abutment surface surrounds the recess. Thereby, a power tool is provided having conditions for a distinct triggering point of the trigger element in which the position of the trigger element relative to the elongated handle causes an activation of the switch. In addition, due to these features, movement of the trigger element past the triggering point can be allowed. In this manner, a more user-friendly power tool can be provided because the switch can be activated in a quick and efficient manner simply by gripping the elongated handle and unintentional deactivations of the switch, for example caused by a loose grip of the elongated handle, can be avoided. Moreover, a power tool is provided having conditions for an activation of the switch upon movement of the trigger element in several directions relative to the elongated handle. In this manner, a power tool is provided having conditions for allowing a user to grip the elongated handle at various gripping directions during operation of the power tool in a simple and efficient manner.

Optionally, the power tool comprises a resilient member biasing the first mechanism member in a direction towards the second mechanism member. Thereby, a power tool is provided having conditions for consistent and reliable activations and deactivations of the switch in a simple, reliable, and cost-efficient manner. In addition, due to the biasing of the first mechanism member in a direction towards the second mechanism member, more distinct and reliable deactivations of the switch can be obtained when a user releases a grip from the elongated handle.

Optionally, the first mechanism member is spherical or elliptical. Thereby, a power tool is provided having conditions for consistent and reliable activations and deactivations of the switch in a simple, reliable, and cost-efficient manner.

Optionally, the mechanism is arranged on the power tool body. Thereby, conditions are provided for shielding the mechanism from dust, debris, water, impact, vibrations, and the like. In this manner, a more robust and reliable power tool can be provided. In addition, since the mechanism is arranged at the power tool body, conditions are provided for a more compact power tool thus being simpler to use.

Optionally, the elongated handle comprises a gripping portion to be gripped by a person, and wherein the trigger element has an activation portion which protrudes from the gripping portion of the elongated handle. Thereby, even more reliable, and accurate activations and deactivations of the switch can be provided when a user is gripping the elongated handle and when the user releases the grip from the elongated handle.

Optionally, the gripping portion of the elongated handle is bent to at least partially enclose an area, and wherein the activation portion protrudes from a slot extending on the gripping portion of the elongated handle and faces the area. Thereby, a power tool is provided having conditions for an activation of the switch upon movement of the trigger element in various directions relative to the elongated handle. In this manner, a power tool is provided having conditions for allowing a user to grip the elongated handle at various gripping directions during operation of the power tool in a simple and efficient manner.

Optionally, the trigger element is a continuous integral body. Thereby, a trigger element is provided having conditions and characteristics suitable for being manufactured and assembled in a cost-efficient manner while being less prone to break.

Optionally, the switch may be set in a first condition in which the power tool is set in inactive-state or in a second condition in which the power tool is set in active-state. Such switches, for example mechanically actuated microswitches, are failsafe, compact and available at a low cost.

Optionally, the power tool comprises a main handle with a main trigger for controlling the speed of the power source. The switch may thereby be a safety-switch which is connected to the main trigger such that the main trigger is disabled when the safety-switch is in the first condition and such that the main trigger is enabled when the safety-switch is in the second condition.

Optionally, the power tool comprises mutually mating guide surfaces for guiding the direction of motion of the trigger element relative the handle. Thereby, a power tool is provided having conditions for consistent and reliable activations and deactivations of the switch in a simple, reliable, and cost-efficient manner.

Optionally, the mutually mating guide surfaces comprises an aperture and a guide pin protruding into the aperture. Thereby, a power tool is provided having conditions for consistent and reliable activations and deactivations of the switch in a simple, reliable, and cost-efficient manner.

Optionally, the power tool is a hedge-trimmer, a string-trimmer, or brush-cutter.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a perspective view of a handheld power tool according to some embodiments,

FIG. 2 illustrates a sectional view of a portion of the power tool illustrated in FIG. 1,

FIG. 3 illustrates a sectional view of some components of the power tool illustrated in FIG. 1 and in FIG. 2,

FIG. 4 illustrates the sectional view of the components of illustrated in FIG. 3 in which a trigger element has been moved to an actuated position relative to an elongated handle of the power tool,

FIG. 5 illustrates a perspective view of a switch assembly of the power tool according to the embodiments illustrated in FIG. 1-FIG. 4,

FIG. 6 illustrates a cross section of the switch assembly illustrated in FIG. 5,

FIG. 7 illustrates the cross section of the switch assembly illustrated in FIG. 6 in which a second mechanism member has been pivoted to an actuated position,

FIG. 8 illustrates a sectional view of the elongated handle of the power tool according to the embodiments illustrated in FIG. 1-FIG. 4, and

FIG. 9 illustrates the sectional view of the elongated handle illustrated in FIG. 8 in which the trigger element has been moved to an actuated position.

### DETAILED DESCRIPTION

Aspects of the present invention will now be described more fully. Like numbers refer to like elements throughout. Well-known functions or constructions will not necessarily be described in detail for brevity and/or clarity.

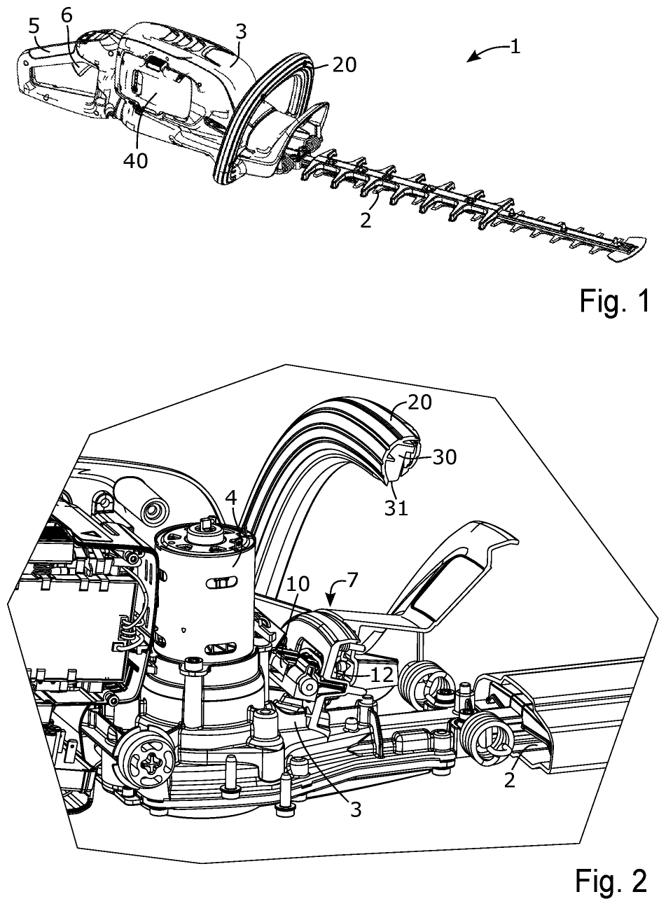

FIG. 1 illustrates a perspective view of a handheld power tool 1 according to some embodiments. According to the illustrated embodiments, the handheld power tool 1 is a hedge trimmer. According to further embodiments, the handheld power tool 1, as referred to herein, is another type of handheld power tool, such as for example a string-trimmer, a brush-cutter, a power-cutter, a chainsaw, a circular-saw, a multi-tool, or the like.

The feature that the handheld power tool 1 is “handheld” means that the handheld power tool is configured to be supported by one or two hands of a user during operation. The handheld power tool 1 according to the illustrated embodiments is configured to be supported by two hands of a user during operation, as is further explained herein. The handheld power tool 1 is in some places herein referred to as the “power tool 1” for reasons of brevity and clarity.

The power tool 1 comprises a power tool body 3, a tool 2, and a power source configured to power the tool 2. The power tool body 3 accommodates a number of components and systems of the power tool 1, such as the power source, as is further explained herein. The power tool body 3 may further comprise several further components which are not visible in FIG. 1 but that are typically provided in power tools and therefore not necessary to describe in detail here within. These components include, but are not limited to, a gearbox, attachments for attaching the tool 2 to the power tool 1, electric wiring circuits, electronic controller for controlling the operation of the power tool 1 and outer buttons, levers, and various controls. In the shown alternative, the tool 2 is a saw-tooth blade for cutting branches of hedges, i.e., a reciprocating cutting tool.

The power tool 1 comprises an elongated handle 20 to be held by a person using the power tool 1. Moreover, the power tool 1 comprises a main handle 5 with a main trigger 6 for controlling the speed and operation of the power source of the power tool 1. Thus, according to the illustrated embodiments, the handheld power tool 1 is configured to be supported by two hands of a user during operation, i.e. one hand gripping the elongated handle 20 and the other hand gripping the main handle 5.

According to the illustrated embodiments, the elongated handle 20 may be denominated a forward secondary handle and the main handle 5 may be denominated a rear primary handle. As shown in FIG. 1, the elongated handle 20 is elongate and bent in a curved form and attached to the power tool body 3 such that it forms a continuous rounded rectangular shape and encloses an area. In operation the elongated handle 20 may be gripped at essentially any position along its length by a person using the power tool 1. For example, a person using the power tool may grip the elongated handle 20 at a first lateral region or at an intermediate region or at a second lateral region. In this manner, a user is allowed to operate the power tool 1 at various orientations as is further explained herein.

FIG. 2 illustrates a sectional view of a portion of the power tool 1 illustrated in FIG. 1. In FIG. 2, some components of the power tool 1 have been removed for reasons of visibility and clarity. In FIG. 2, a portion of the power tool body 3 and a portion of the tool 2 of the power tool 1 can be seen. Moreover, the power source 4 of the power tool 1 can be seen in FIG. 2. According to the illustrated embodiments, the power source 4 is an electric motor supplied with electricity from a battery. The battery 40 of the power tool 1 is indicated in FIG. 1. According to further embodiments, the power source 4 may be supplied with electricity from another type of arrangement, such as a power cord. Moreover, according to further embodiments, the power source 4, as referred to herein, may be another type of power source than an electric motor, such as a combustion engine, a pneumatic motor, or the like.

Moreover, in FIG. 2, a section of the elongated handle 20 can be seen. As can be seen in FIG. 2, the elongated handle 20 comprises a trigger element 30 extending along at least a portion of the elongated handle 20. The trigger element 30 is arranged movable relative the elongated handle 20 such that the trigger element 30 moves relative the elongated handle 20 when a person grips the elongated handle 20, as is further explained herein.

Furthermore, in FIG. 2, a switch 10 and a mechanism 7 of the power tool 1 can be seen. As is further explained herein, the switch 10 is operably connected to the trigger element 30 via the mechanism 7. In other words, the mechanism 7 operably connects the trigger element 30 and the switch 10. The switch 10 is configured to set the power tool 1 in an active-state or an inactive-state based on the position of the trigger element 30. As seen in FIG. 2, the switch 10 is arranged at the power tool body 3.

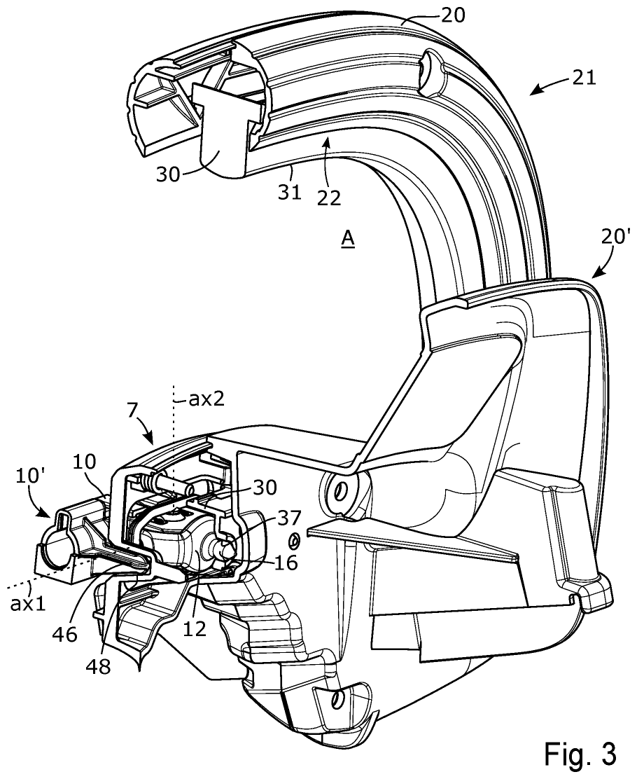

FIG. 3 illustrates a sectional view of some components of the power tool 1 illustrated in FIG. 1 and in FIG. 2. In FIG. 3, a handle assembly 20′ and a switch assembly 10′ of the power tool can be seen. The handle assembly 20′ comprises the elongated handle 20 and the switch assembly 10′ comprises the switch 10. The switch assembly 10′ and the handle assembly 20′ are configured to be mounted to the power tool body 3 of the power tool 1 indicated in FIG. 1 and FIG. 2. The switch assembly 10′ and the handle assembly 20′ may be rigidly attached to the power tool body 3 of the power tool 1. Below, simultaneous reference is made to FIG. 1-FIG. 3, if not indicated otherwise.

The switch assembly 10′ comprises a protrusion 46 and the handle assembly 20′ comprises a recess 48. The protrusion 46 is formed as a guide pin and is configured to protrude into the recess 48 of the handle assembly 20′ when the switch assembly 10′ and the handle assembly 20′ are in an assembled state, as is illustrated in FIG. 3. The protrusion 46 and the recess 48 facilitates assembly and alignment of the switch assembly 10′ and the handle assembly 20′. According to the illustrated embodiments, the switch assembly 10′ comprises two protrusions 46 and the handle assembly 20′ comprises two recesses 48. However, in FIG. 3, only one of the protrusions 46 and only one of the recesses 48 is visible. According to further embodiments, the switch assembly 10′ may comprise one or more recesses and the handle assembly 20′ may comprise one or more protrusions configured to protrude into a recess of the switch assembly 10′ when the switch assembly 10′ and the handle assembly 20′ are in an assembled state.

The elongated handle 20 comprises a gripping portion 21 to be gripped by a person. The trigger element 30 has an activation portion 31 which protrudes from the gripping portion 21 of the elongated handle 20. The gripping portion 21 of the elongated handle 20 is bent to at least partially enclose an area A. The activation portion 31 protrudes from a slot 22 extending on the gripping portion 21 of the elongated handle 20 and faces the area A. The trigger element 30 is moveable arranged in the slot 22. In FIG. 3, the trigger element 30 is illustrated in a non-actuated position. As is further explained herein, the trigger element 30 is configured to assume the non-actuated position when not being subjected to an external force, such as a gripping force of a hand of a user.

Moreover, in FIG. 3, a second mechanism member 12 of the mechanism 7 can be seen. The second mechanism member 12 of the mechanism 7 is operably connected to the trigger element 30 and is configured to move upon movement of the trigger element 30. According to the illustrated embodiments, the trigger element 30 comprises an aperture 37 and the second mechanism member 12 comprises a knob 16 protruding into the aperture 37 of the trigger element 30. In this manner, the second mechanism member 12 is operably connected to the trigger element 30. According to further embodiments, the second mechanism member of the mechanism 7 may be operably connected to the trigger element 30 in another manner. As an example, the second mechanism member 12 may comprise comprises an aperture and the trigger element 30 may comprise a knob protruding into the aperture of the second mechanism member 12 of the mechanism 7.

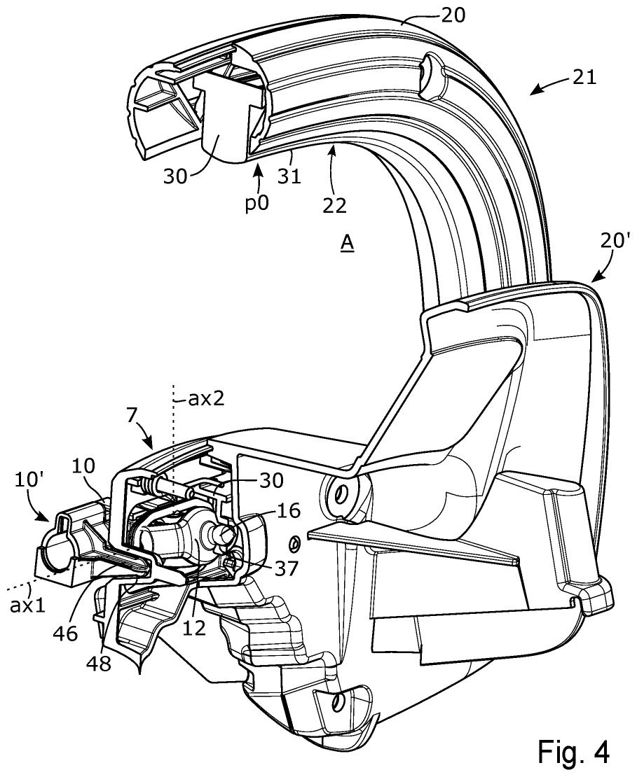

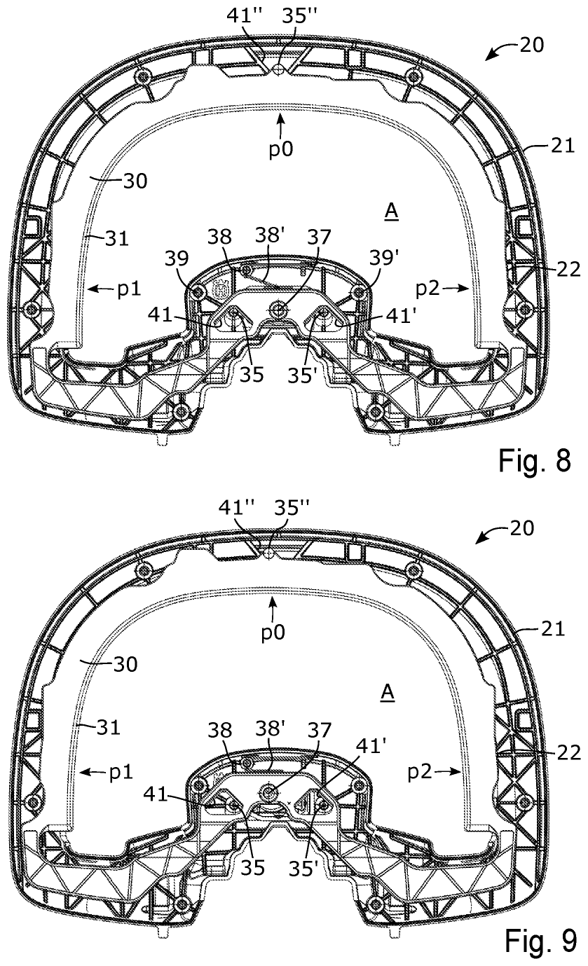

FIG. 4 illustrates the sectional view of the components of illustrated in FIG. 3 in which the trigger element 30 has been moved relative to the elongated handle 20 to an actuated position. In FIG. 4, the trigger element 30 is illustrated in a position corresponding to a situation in which a user grips a centre portion p0 of the gripping portion 21 of the elongated handle 20. The different portions p0 of the gripping portion 21 of the elongated handle 20 and the movability of the trigger element 30 relative to the elongated handle 20 is further explained with reference to FIG. 8 and FIG. 9 below.

As can be seen in FIG. 4, the second mechanism member 12 of the mechanism 7 has been moved as a result of the movement of the trigger element 30 to the actuated position.

According to the illustrated embodiments, the second mechanism member 12 is pivotally arranged relative to the switch assembly 10′ around a first pivot axis ax1 and around a second pivot axis ax2, wherein the second pivot axis ax2 is transversal to the first pivot axis ax1. As is further explained herein, according to the illustrated embodiments, the second pivot axis ax2 is perpendicular to the first pivot axis ax1. Moreover, the second pivot axis ax2 extends through the first pivot axis ax1.

According to further embodiments, the second mechanism member 12 may be moveably arranged relative to the switch assembly 10′ in another manner, such as around one pivot axis ax1, ax2. The position of the second mechanism member 12 of the mechanism 7 illustrated in FIG. 4 is below referred to as an actuated position, even though the second mechanism member 12 of the mechanism 7 as well as the trigger element 30 of the elongated handle 20, is movable to different actuated positions, as is further explained in the following.

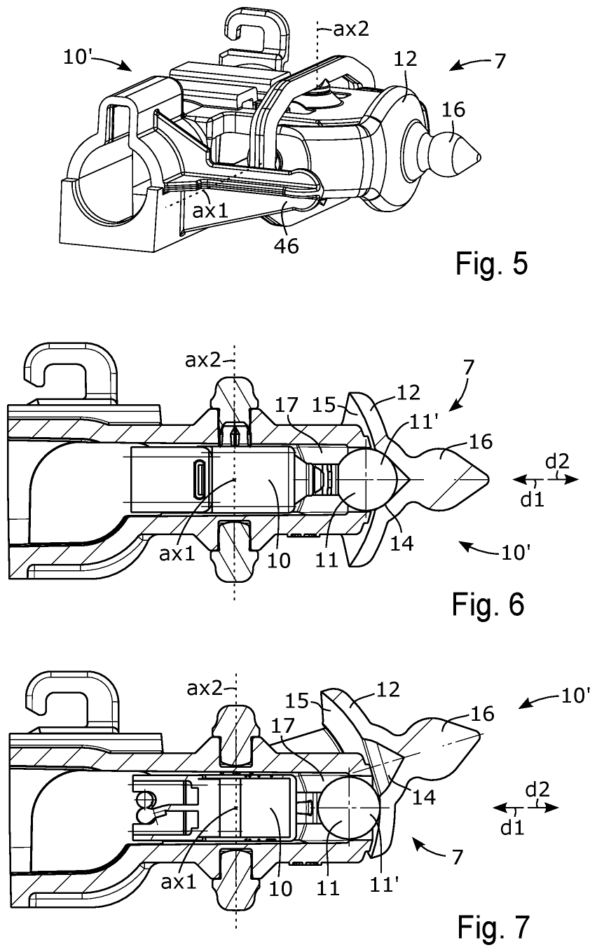

FIG. 5 illustrates a perspective view of the switch assembly 10′ of the power tool 1 according to the embodiments illustrated in FIG. 1-FIG. 4. In FIG. 5, the second mechanism member 12 of the mechanism 7 is illustrated in an unactuated position. As clearly seen in FIG. 5, the knob 16 of the second mechanism member 12 has a curved convex shape. Moreover, according to the illustrated embodiments, the aperture 37 of the trigger element 30, indicated in FIG. 4 and FIG. 5, has a matching curved concave shape. In this manner, the interface between the knob 16 and the aperture 37 can allow an angular displacement of the second mechanism member 12 relative to the aperture 37 of the trigger element 30 in a simple, reliable, and efficient manner.

FIG. 6 illustrates a cross section of the switch assembly 10′ illustrated in FIG. 5. In FIG. 6, the cross section is made in a plane comprising the second pivot axis ax2 of the second mechanism member 12. Moreover, in FIG. 6, the cross section is made in a plane being perpendicular to the first pivot axis ax1 of the second mechanism member 12. In FIG. 6, the second mechanism member 12 of the mechanism 7 is illustrated in the unactuated position.

As can be seen in FIG. 6, the mechanism 7 comprises a first mechanism member 11. As is further explained herein, the mechanism 7 is configured such that a first mechanism member of the mechanism 7 is moved in a direction d1 towards the switch 10 when the elongated handle 20 is gripped. According to the illustrated embodiments, the second mechanism member 12 is in abutting contact with the first mechanism member 11. Thus, according to the illustrated embodiments, the second mechanism member 12 is connected to the trigger element 30, indicated in FIG. 4, and to the first mechanism member 11, by being in abutting contact with the trigger element 30 and with the first mechanism member 11.

In more detail, according to the illustrated embodiments, the second mechanism member 12 comprises a recess 14. As can be seen in FIG. 6, a section 11′ of the first mechanism member 11 protrudes into the recess 14 when the second mechanism member 12 is in the unactuated position. The second mechanism member 12 is thus movable to a position in which the section 11′ of the first mechanism member 11 protrudes into the recess 14. According to the illustrated embodiments, the first mechanism member 11 is spherical. According to further embodiments, the first mechanism member 11 may have a different form or shape, such as curved, elliptical, or the like.

Moreover, according to the illustrated embodiments, the mechanism 7 comprises a resilient member 17 biasing the first mechanism member 11 in a direction d2 towards the second mechanism member 12. In this manner, an abutting contact between the first mechanism member 11 and second mechanism member 12 can be ensured regardless of the pivoting position of the second mechanism member 12 relative to the switch assembly 10′. The resilient member 17 may comprise a spring, such as a coil spring, or the like. As an alternative, the resilient member 17 may comprise another type of elastic element.

Moreover, as indicated in FIG. 6, the second mechanism member 12 comprises an abutment surface 15 adjacent to the recess 14. According to the illustrated embodiments, the abutment surface 15 surrounds the recess 14. The second mechanism member 12 is configured to move the first mechanism member 11 in the direction d1 towards the switch 10 by an abutting contact between the abutment surface 15 and the first mechanism member 11. In other words, the first mechanism member 11 is configured to move relative to the switch 10 upon movement of the second mechanism member 12.

FIG. 7 illustrates the cross section of the switch assembly 10′ illustrated in FIG. 6 in which the second mechanism member 12 has been pivoted to the actuated position. As can be seen in FIG. 7, the first mechanism member 11 is moved in the direction d1 towards the switch 10 by the abutting contact between the first mechanism member 11 and the abutment surface 15 of the second mechanism member 12 when the second mechanism member 12 is pivoted to the actuated position. Moreover, as can be seen in FIG. 7, according to the illustrated embodiments, the section 11′ of the first mechanism member 11 is moved out from the recess 14 when the second mechanism member 12 is pivoted to the actuated position.

The first mechanism member 11 is configured to activate the switch 10 by pressing against the switch 10 when being displaced in the direction d1 towards the switch 10. The switch 10 may be a mechanically actuated microswitch that closes an electric circuit when it is actuated by a pressing force of the first mechanism member 11 and that breaks the electric circuit when the pressing force is removed. In this manner, the switch 10 can be activated in a simple, reliable, and efficient manner. Moreover, due to these features of the mechanism 7, a mechanically actuated microswitch can be used which is failsafe, compact and available at a low cost.

As understood from the herein described, the mechanism 7 is configured such that the first mechanism member 11 is moved relative to the switch 10 upon a pivoting movement of the second mechanism member 12. According to the illustrated embodiments, the abutment surface 15 is bowl-shaped and has a radius of curvature substantially equal to the distance between the abutment surface 15 and a point in which the first and second pivot axes ax1, ax2 crosses each other. In other words, according to the illustrated embodiments, the mechanism 7 is configured such that the distance from the point in which the first and second pivot axes ax1, ax2 crosses each other to different portions of the abutment surface 15 is substantially equal across the abutment surface 15. Thereby, due to these features, an early activation of the switch can be provided while allowing movement of the second mechanism member 12 past the triggering point, i.e. the point in which the second mechanism member triggers an actuation of the switch 10. In this manner, a more user-friendly power tool can be provided. In addition, due to the features of the mechanism 7, a switch assembly 10′ is provided having conditions for operating in an efficient manner in various types of power tools, as is further explained herein.

When the second mechanism member 12 is pivoted to the unactuated position, as illustrated in FIG. 6, the first mechanism member 11 is moved in a direction d2 away from the switch 10 by the biasing force of the resilient member 17 such that a section 11′ of the first mechanism member 11 protrudes into the aperture 14 of the second mechanism member 12. The switch is thereby deactivated when the first mechanism member 11 is moved in the direction d2 away from the switch 10. In this manner, the switch 10 is deactivated in a simple, reliable, and efficient manner. As understood from the herein described, according to the illustrated embodiments, the direction d2 away from the switch 10 is in this context the same direction as a direction d2 towards the second mechanism member 12.

FIG. 8 illustrates a sectional view of the elongated handle 20 of the power tool 1 according to the embodiments illustrated in FIG. 1-FIG. 4. In FIG. 8, one housing part of the elongated handle 20 has been removed for reasons of visibility. As can be seen in FIG. 8, the trigger element 30 is a continuous integral body, i.e. is made of one piece of continuous material. The trigger element 30 may for example be made of a polymeric material. Due to these features, trigger element 30 is provided having conditions and characteristics suitable for being manufactured and assembled in a cost-efficient manner while being durable.

As explained above, the trigger element 30 has an activation portion 31 which protrudes from the gripping portion 21 of the elongated handle 20. The gripping portion 21 of the elongated handle 20 is bent to enclose an area A. The activation portion 31 protrudes from a slot 22 extending on the gripping portion 21 of the elongated handle 20. The activation portion 31 faces the area A and the trigger element 30 is moveable arranged in the slot 22. The slot 22 is directed inwards towards the area A that is enclosed by the elongated handle 20. The trigger element 30 is arranged within the elongated handle 20. The trigger element 30 may be designed such that its shape corresponds to the shape of the elongated handle 20. The activation portion 31 of the trigger element 30 extends through the slot 22 in the elongated handle 20 into the area A. When a person grips the gripping portion 21 of the elongated handle 20 the activation portion 31 will be gripped simultaneously. The trigger element 30 is movable within the elongated handle 20 and the trigger element 30 may thus move within the elongated handle 20 when the activation portion 31 is gripped.

In FIG. 3, the trigger element 30 is illustrated in a non-actuated position. According to the illustrated embodiments, the non-actuated position may also be referred to as a centred position because the trigger element 30 is aligned with a symmetry axis of the elongated handle 20 when in the non-actuated position. As is further explained herein, the trigger element 30 is configured to assume the non-actuated position when not being subjected to an external force, such as a gripping force of a hand of a user. According to the illustrated embodiments, the power tool 1 comprises a resilient member 38 configured to bias the trigger element 30 towards the non-actuated position. The features and functions of the resilient member 38 is further explained with reference to FIG. 9 below.

As can be seen in FIG. 8, since the gripping portion 21 of the elongated handle 20 is bent to enclose the area A, a user may grip various portions p0, p1, p2 of the gripping portion 21 of the elongated handle 20. Thereby, the user is allowed to operate the power tool 1 at various orientations. In the following, the portion p0 of the gripping portion 21 of the elongated handle is referred to as a centre portion p0, the portion p1 of the gripping portion 21 of the elongated handle 20 is referred to as a first side portion p1, and the portion p2 of the gripping portion 21 of the elongated handle 20 is referred to as a second side portion p2. The centre portion p0 of the gripping portion 21 of the elongated handle 20 may also be referred to as an intermediate region of the gripping portion 21. The first side portion p1 of the gripping portion of the elongated handle 20 may also be referred to as a first lateral region of the gripping portion 21. The second side portion p2 of the gripping portion 21 of the elongated handle 20 may also be referred to as a second lateral region of the gripping portion 21.

FIG. 9 illustrates the sectional view of the elongated handle 20 illustrated in FIG. 8 in which the trigger element 30 has been moved to an actuated position. In FIG. 9, the trigger element is illustrated in an actuated position corresponding to a situation in which a user is gripping the first side portion p1 of the gripping portion 21 of the elongated handle 20. Below, simultaneous reference is made to FIG. 1-FIG. 9 if not indicated otherwise. As can be seen when comparing FIG. 8 and FIG. 9, the trigger element 30 has been moved in a direction towards the first side portion p1 in FIG. 9. Due to the relative movement of the aperture 37 of the trigger element 30 and the elongated handle 20, the trigger element 30 moves the second mechanism member 12 to a position in which the first mechanism member 11 is pressed against the switch 10. Accordingly, due to the relative movement of the trigger element 30 and the elongated handle 20, the switch 10 is actuated when a user is gripping a portion p0, p1, p2 of the gripping portion 21 of the elongated handle 20.

As can be seen in FIG. 8 and FIG. 9, the power tool 1 comprises mutually mating guide surfaces 35, 35′, 35″, 41, 41′, 41″ for guiding the direction of motion of the trigger element 30 relative the elongated handle 20. In more detail, according to the illustrated embodiments, the mutually mating guide surfaces 35, 35′, 35″, 41, 41′, 41″ comprises a number of apertures 41, 41′, 41″ and number of guide pins 35, 35′, 35″, wherein each guide pin 35, 35′, 35″ is protruding into one of the apertures 41, 41′, 41″. According to the illustrated embodiments, the elongated handle 20 comprises the apertures 41, 41′, 41″ and the trigger element 30 comprises the guide pins 35, 35′, 35″. According to further embodiments, the trigger element 30 may comprise a number of the apertures and the elongated handle 20 may comprise a number of guide pins each protruding into one of the apertures of the trigger element 30.

As can be seen in FIG. 8 and FIG. 9, according to the illustrated embodiments, the apertures 41, 41′, 41″ have a substantially triangular shape. Due to the shape of the apertures 41, 41′, 41″ according to the illustrated embodiments, the trigger element 30 is forced in a direction upwards in FIG. 8 and FIG. 9, i.e. in a direction towards the centre portion p0 of the gripping portion 21, also when one of the first and second side portions p1, p2 is gripped. Thus, as understood from the above, and as can be seen when comparing FIG. 8 and FIG. 9, the trigger element 30 is simultaneously moved towards the first side portion p1 and the centre portion p0 when the first side portion p1 is gripped due to the mutually mating guide surfaces 35, 35′, 35″, 41, 41′, 41″.

When the centre portion p0 is gripped, the abutting contact between the guide pins 35, 35′, 35″ and the apertures 41, 41′, 41″ is released and the guide pins 35, 35′, 35″ are moved to positions within the respective aperture 41, 41′, 41″. Due the mutually mating guide surfaces 35, 35′, 35″, 41, 41′, 41″, the trigger element 30 is moved within the elongated handle 20 in a predetermined manner upon gripping different portions p0, p1, p2 of the gripping portion 21 of the elongated handle 20. Moreover, the mating guide surfaces 35, 35′, 35″, 41, 41′, 41″ limits relative movement between the trigger element 30 and the elongated handle 20.

As mentioned above, the power tool 1 comprises a resilient member 38 configured to bias the trigger element 30 towards the non-actuated position. According to the illustrated embodiments, the resilient member 38 is configured to configured to bias the trigger element in a direction downwards in FIG. 8 and FIG. 9 relative to the elongated handle 20, i.e. in a direction away from the centre portion p0 of the gripping portion 21 elongated handle 20.

Moreover, due to the shape of the apertures 41, 41′, 41″ according to the illustrated embodiments, the trigger element 30 is forced in a direction upwards in FIG. 8 and FIG. 9, i.e. in a direction towards the centre portion p0 of the gripping portion 21, regardless of the moving direction of the trigger element 30 relative to the elongated handle 20 from the non-actuated position of the trigger element 30. In this manner, the resilient member 38 is compressed when the trigger element 30 moves relative to the elongated handle 20 from the non-actuated position regardless of the moving direction therefrom, which also can be seen when comparing FIG. 8 and FIG. 9. Due to these features, a simple and accurate control of the movement of the trigger element 30 is provided. According to the illustrated embodiments, the resilient member 38 is a torsion spring attached to the elongated handle 20, wherein the resilient member 38 comprises an arm 38′ abutting against a portion the trigger element 30.

According to further embodiments, the power tool 1 may comprise a blade spring configured to bias the trigger element 30 towards the non-actuated position. Such a blade spring may for example be attached to the elongated handle 20 at the mounting points 39, 39′ indicated in FIG. 8, wherein the blade spring may comprise a centre portion abutting against the trigger element 30 so as to bias the trigger element 30 towards the non-actuated position. As an alternative, or in addition, the power tool 1 may comprise one or more other types of resilient elements for biasing the trigger element 30 towards the non-actuated position, such as for example one or more coil springs, elastic elements, or the like.

Due to the features of the mechanism 7, and the fact that the second mechanism member 12 is pivotally arranged relative to the switch assembly 10′ around a first pivot axis ax1 and around a second pivot axis ax2 being transversal to the first pivot axis ax1, the second mechanism member 12 is rotatable 360 degrees. Moreover, as is best seen in FIG. 5, the function and the attachment of the second mechanism member 12 to the switch assembly 10′ resembles a cardan joint, except the fact that a cardan joint normally is configured to transfer torque for example in a power transmission.

Moreover, as explained with reference to FIG. 6 and FIG. 7 above, due to the features of the mechanism 7, an early actuation of the switch 10 can be obtained when the trigger element is moved relative to the elongated handle 20. In addition, due to the features of the mechanism 7, the trigger element 30 can be moved past positions in which the switch 10 is actuated. In this manner, a more user-friendly power tool 1 can be provided having a better feel and comfort when gripping the elongated handle 20.

Furthermore, due to the features of the mechanism 7, the switch assembly 10′ can be used in various types of power tools without further modifications, or at least with a low number of modifications, which lowers manufacturing costs, development costs, and assembling costs of power tools.

According to embodiments herein, the switch 10 may be set in a first condition in which the power tool 1 is set in inactive-state or in a second condition in which the power tool 1 is set in active-state. The switch 10 may be a safety-switch connected to the main trigger 6 such that the main trigger 6 is disabled when the switch 10 is in the first condition and such that the main trigger 6 is enabled when the switch 10 is in the second condition.

Thus, the switch 10 of the power tool 1 may be configured to set the power tool 1 in either an active or inactive state. By “active state” is meant that a tool 2 attached to the power tool 1 may be set in motion. By “inactive state” is meant that the tool 2 may not be set in motion. Thus, when the power tool 1 is in “active state”, the power source 4 and the main trigger 6 and other parts relevant for motion of the tool are enabled. When the power tool 1 is in “inactive state” anyone of the power source 4 and the main trigger 6 and other parts relevant for motion of the tool 2 are disabled.

The switch 10 may typically be set in either of a first condition and a second condition. The switch 10, and the power tool 1 are thereby configured such that when the switch 10 is in the first condition the power tool 1 is in inactive state and when the switch 10 is in the second condition the power tool 1 is in active state. To achieve this, the switch 10 may be connected electrically or mechanically to all or anyone of the power source 4, the main trigger 6 or any other relevant parts of the power tool 1. Such configuration lies within the knowledge of skilled person and may not need to be described further here within.

According to one alternative, the switch 10 may be connected to the power source 4 such that the power source 4 is on when the switch 10 is in the second condition and such that the power source 4 is off when the switch 10 is in the first condition. According to a second alternative, the switch 10 be connected to the main trigger 6 such that main trigger 6 is enabled when the switch 10 is in the second condition and such that the main trigger 6 is disabled (e.g. locked) when the switch 10 is in the first condition. These two alternatives may be combined.

Generally, the power tool 1 may be configured such that it starts when the gripping portion 21 of the elongated handle 20 is gripped and the main trigger 6 of the rear handle 5 is pressed.

The switch 10 may be a mechanically actuated microswitch that closes an electric circuit when it is actuated by a pressing force of the first mechanism member 11 (i.e. second condition) and that breaks the electric circuit when the pressing force of the first mechanism member 11 is removed (i.e. first condition).

Any references to direction or positions such as “above” or “below” or “upper” or “lower” or “upwards” or downwards” as used herein are in relation to a situation in which the hand-held power tool is held parallel, such as horizontal, to a ground surface. In such a situation, an intermediate centre portion of the handle may be directed orthogonally, such as vertically, away from the ground surface.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A handheld power tool comprising:
a power tool body,
a tool,
a power source configured to power the tool,
a switch configured to set the power tool in an active-state or an inactive-state, and
an elongated handle to be held by a person using the power tool,
the elongated handle comprising a trigger element extending along at least a portion of the elongated handle and being arranged movable relative the elongated handle such that the trigger element moves relative the handle when a person grips the handle,
wherein the switch is arranged at the power tool body, and
wherein the power tool comprises a mechanism operably connected to the trigger element, and wherein the mechanism is configured such that a first mechanism member of the mechanism is moved in a direction towards the switch when the handle is gripped.

2. The power tool according to claim 1, wherein the mechanism comprises a second mechanism member connected to the trigger element and to the first mechanism member, and wherein the first mechanism member is configured to move relative to the switch upon movement of the second mechanism member.

3. The power tool according to claim 2, wherein the mechanism is configured such that the first mechanism member is moved relative to the switch upon a pivoting movement of the second mechanism member.

4. The power tool according to claim 2, wherein the second mechanism member is pivotally arranged around a first pivot axis.

5. The power tool according to claim 4, wherein the second mechanism member is pivotally arranged around a second pivot axis being transversal to the first pivot axis.

6. The power tool according to claim 2, wherein the trigger element comprises an aperture, and wherein the second mechanism member comprises a knob protruding into the aperture.

7. The power tool according to claim 2, wherein the second mechanism member comprises a recess, and wherein the second mechanism member is movable to a position in which a section of the first mechanism member protrudes into the recess.

8. The power tool according to claim 7, wherein the first mechanism member is moved in the direction towards the switch when the section of the first mechanism member is moved out from the recess.

9. The power tool according to claim 7, wherein the second mechanism member comprises an abutment surface adjacent to the recess, and wherein the second mechanism member is configured to move the first mechanism member in the direction towards the switch by an abutting contact between the abutment surface and the first mechanism member.

10. The power tool according to claim 9, wherein the abutment surface is curved and/or bowl-shaped.

11. The power tool according to claim 2, wherein the power tool comprises a resilient member biasing the first mechanism member in a direction towards the second mechanism member.

12. The power tool according to claim 1, wherein the first mechanism member is spherical or elliptical.

13. The power tool according to claim 1, wherein the mechanism is arranged on the power tool body.

14. The power tool according to claim 1, wherein the elongated handle comprises a gripping portion to be gripped by a person, and wherein the trigger element has an activation portion which protrudes from the gripping portion of the elongated handle.

15. The power tool according to claim 14, wherein the gripping portion of the elongated handle is bent to at least partially enclose an area, and wherein the activation portion protrudes from a slot extending on the gripping portion of the elongated handle and faces the area.

16. The power tool according claim 1, wherein the power tool (comprises mutually mating guide surfaces for guiding the direction of motion of the trigger element relative the handle.

17. The power tool according to claim 16, wherein the mutually mating guide surfaces comprise an aperture and a guide pin protruding into the aperture.

18. The power tool according to claim 1, wherein the power tool is a hedge-trimmer, a string trimmer, or brush-cutter.
